(19) United States
(12) Patent Application Publication
(10) Pub. No.: US 2012/0059971 A1
(43) Pub. Date: Mar. 8, 2012

(54) METHOD AND APPARATUS FOR HANDLING CRITICAL BLOCKING OF STORE-TO-LOAD FORWARDING

(76) Inventors: DAVID KAPLAN, Austin, TX (US); Tarun Nakra, Austin, TX (US); Christopher D. Bryant, Austin, TX (US); Bradley Burgess, Austin, TX (US)

(21) Appl. No.: 12/876,912

(22) Filed: Sep. 7, 2010

(51) Int. Cl. G06F 12/08; G06F 12/00

(52) U.S. Cl. 711/3; 711/141; 711/200; 711/E12.001; 711/E12.026

(57) ABSTRACT

The present invention provides a method and apparatus for handling critical blocking of store-to-load forwarding. One embodiment of the method includes recording a load that matches an address of a store in a store queue before the store has valid data. The load is blocked because the store does not have valid data. The method also includes replaying the load in response to the store receiving valid data so that the valid data is forwarded from the store queue to the load.

### BACKGROUND OF THE INVENTION

1. Field of the Invention

This invention relates generally to processor-based systems, and, more particularly, to handling critical blocking of store-to-load forwarding in a processor-based system.

2. Description of the Related Art

Processor-based systems utilize two basic memory access instructions: a store that puts (or stores) information in a memory location such as a register and a load that reads information out of a memory location. High-performance out-of-order execution microprocessors can execute memory access instructions (loads and stores) out of program order. For example, a program code may include a series of memory access instructions including loads (L1, L2, . . . ) and stores (S1, S2, . . . ) that are to be executed in the order: S1, L1, S2, L2, . . . . However, an instruction picker in the processor may select the instructions in a different order such as L1, L2, S1, S2, . . . . When attempting to execute instructions out of order, the processor must respect true dependencies between instructions because executing loads and stores out of order can produce incorrect results if a dependent load/store pair was executed out of order. For example, if S1 stores data to the same physical address that L1 subsequently reads data from, the store S1 must be completed (or retired) before L1 is performed so that the correct data is stored at the physical address for the L1 to read.

Store and load instructions typically operate on memory locations in one or more caches associated with the processor. Values from store instructions are not committed to the memory system (e.g., the caches) immediately after execution of the store instruction. Instead, the store instructions, including the memory address and store data, are buffered in a store queue for a selected time interval. Buffering allows the stores to be written in correct program order even though they may have been executed in a different order. At the end of the waiting time, the store retires and the buffered data is written to the memory system. Buffering stores until retirement can avoid dependencies that cause an earlier load to receive an incorrect value from the memory system because a later store was allowed to execute before the earlier load. However, buffering stores can introduce other complications. For example, a load can read an old, out-of-date value from a memory address if a store executes and buffers data for the same memory address in the store queue and the load attempts to read the memory value before the store has retired.

A technique called store-to-load forwarding can provide data directly from the store queue to a requesting load. For example, the store queue can forward data from completed but not-yet-retired (“in-flight”) stores to later (younger) loads. The store queue in this case functions as a Content-Addressable Memory (CAM) that can be searched using the memory address instead of a simple FIFO queue. When store-to-load forwarding is implemented, each load searches the store queue for in-flight stores to the same address. The load can obtain the requested data value from a matching store that is logically earlier in program order (i.e. older). If there is no matching store, the load can access the memory system to obtain the requested value as long as any preceding matching stores have been retired and have committed their values to the memory.

Multiple stores to the load's memory address may be present in the store queue. To handle this case, the store queue can be priority encoded to select the latest (or youngest) store that is logically earlier than the load in program order. Instructions can be time-stamped as they are fetched and decoded to determine the age of stores in the store queue. Alternatively the relative position (slot) of the load with respect to the oldest and newest stores within the store queue can be used to determine the age of each store. Nevertheless, in some situations a load can be picked and there may be a completed store that wants to forward data from the store queue to the load. However, the store may not yet have the requested data and so may not be able to forward the data to the load.

### SUMMARY OF THE INVENTION

The disclosed subject matter is directed to addressing the effects of one or more of the problems set forth above. The following presents a simplified summary of the disclosed subject matter in order to provide a basic understanding of some aspects of the disclosed subject matter. This summary is not an exhaustive overview of the disclosed subject matter. It is not intended to identify key or critical elements of the disclosed subject matter or to delineate the scope of the disclosed subject matter. Its sole purpose is to present some concepts in a simplified form as a prelude to the more detailed description that is discussed later.

In one embodiment, a method is provided for handling critical blocking of store-to-load forwarding. One embodiment of the method includes recording a load that matches an address of a store in a store queue before the store has valid data. The load is blocked because the store does not have valid data. The method also includes replaying the load in response to the store receiving valid data so that the valid data is forwarded from the store queue to the load.

In another embodiment, an apparatus is provided for handling critical blocking of store-to-load forwarding. One embodiment of the apparatus includes a store queue for holding stores, store addresses, and data for the stores. The apparatus also includes a processor core configured to record a load that matches an address of a store in the store queue before the store has valid data. The load is blocked because the store does not have valid data. The processor core is also configured to replay the load in response to the store receiving valid data so that the valid data is forwarded from the store queue to the load.

### BRIEF DESCRIPTION OF THE DRAWINGS

The disclosed subject matter may be understood by reference to the following description taken in conjunction with the accompanying drawings, in which like reference numerals identify like elements, and in which:

FIG. 1 conceptually illustrates a first exemplary embodiment of a semiconductor device that may be formed in or on a semiconductor wafer;

FIG. 2 conceptually illustrates a first exemplary embodiment of a sequence of events during store-to-load forwarding;

FIG. 3A conceptually illustrates a second exemplary embodiment of a sequence of events during store-to-load forwarding;

FIG. 3B conceptually illustrates a third exemplary embodiment of a sequence of events during store-to-load forwarding; and

FIG. 4 conceptually illustrates one exemplary embodiment of a method of handling critical blocking of store-to-load forwarding.

While the disclosed subject matter is susceptible to various modifications and alternative forms, specific embodiments thereof have been shown by way of example in the drawings and are herein described in detail. It should be understood, however, that the description herein of specific embodiments is not intended to limit the disclosed subject matter to the particular forms disclosed, but on the contrary, the intention is to cover all modifications, equivalents, and alternatives falling within the scope of the appended claims.

### DETAILED DESCRIPTION OF SPECIFIC EMBODIMENTS

Illustrative embodiments are described below. In the interest of clarity, not all features of an actual implementation are described in this specification. It will of course be appreciated that in the development of any such actual embodiment, numerous implementation-specific decisions should be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The disclosed subject matter will now be described with reference to the attached figures. Various structures, systems and devices are schematically depicted in the drawings for purposes of explanation only and so as to not obscure the present invention with details that are well known to those skilled in the art. Nevertheless, the attached drawings are included to describe and explain illustrative examples of the disclosed subject matter. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

Generally, the present application describes embodiments of techniques for handling critical blocking of store-to-load forwarding. As used herein, the term “critical blocking” refers to blocking of a load by a store that would have forwarded to the load except that the store does not yet have valid data. Except for the absence of valid data, the store is qualified to forward data to the load. Embodiments of the system described herein can identify critical blocks caused by stores that are qualified to forward data once it becomes available to the store. Critically blocked loads can then be replayed (e.g., a new attempt to execute the load instruction can be made) when the store receives valid data so that the valid data is forwarded from the store queue to the load. This approach provides numerous performance advantages over holding all the stores that blocked the load and waiting for them all to get data and/or retire. Handling critical blocking in the manner described in the present application may also provide a power advantage over replaying the load whenever any one of the stores that blocked the load receives data.

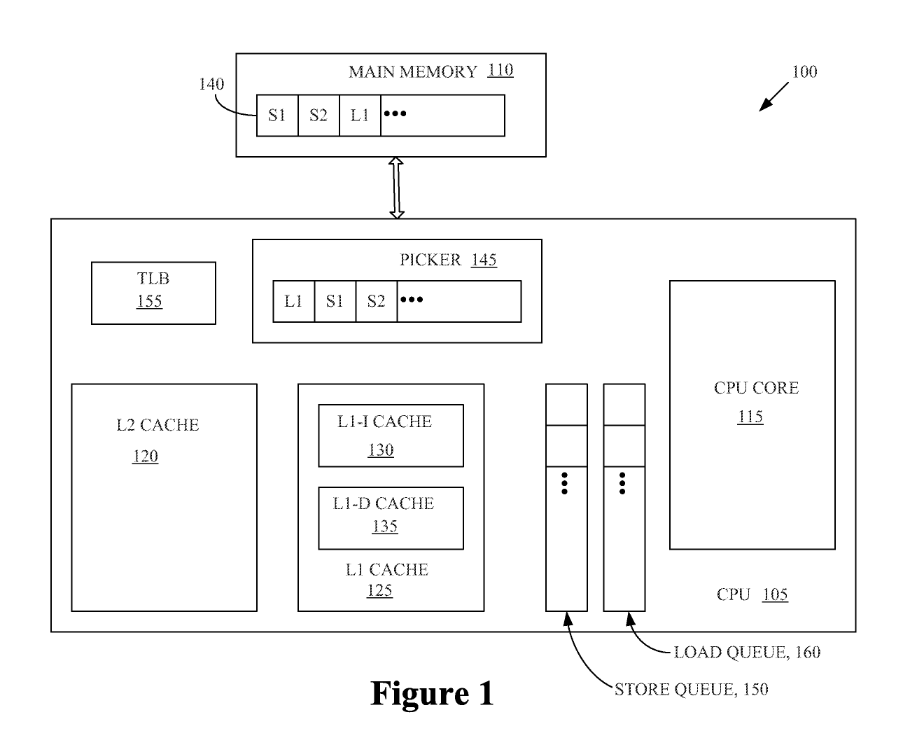

FIG. 1 conceptually illustrates a first exemplary embodiment of a semiconductor device 100 that may be formed in or on a semiconductor wafer (or die). The semiconductor device 100 may formed in or on the semiconductor wafer using well known processes such as deposition, growth, photolithography, etching, planarising, polishing, annealing, and the like. In the illustrated embodiment, the device 100 includes a central processing unit (CPU) 105 that is configured to access instructions and/or data that are stored in the main memory 110. In the illustrated embodiment, the CPU 105 includes a CPU core 115 that is used to execute the instructions and/or manipulate the data. The CPU 105 also implements a hierarchical (or multilevel) cache system that is used to speed access to the instructions and/or data by storing selected instructions and/or data in the caches. However, persons of ordinary skill in the art having benefit of the present disclosure should appreciate that alternative embodiments of the device 100 may implement different configurations of the CPU 105, such as configurations that use external caches. Alternative embodiments may also implement different types of processors such as graphics processing units (GPUs).

The illustrated cache system includes a level 2 (L2) cache 120 for storing copies of instructions and/or data that are stored in the main memory 110. In the illustrated embodiment, the L2 cache 120 is 16-way associative to the main memory 110 so that each line in the main memory 110 can potentially be copied to and from 16 particular lines (which are conventionally referred to as “ways”) in the L2 cache 120. However, persons of ordinary skill in the art having benefit of the present disclosure should appreciate that alternative embodiments of the main memory 110 and/or the L2 cache 120 can be implemented using any associativity. Relative to the main memory 110, the L2 cache 120 may be implemented using smaller and faster memory elements. The L2 cache 120 may also be deployed logically and/or physically closer to the CPU core 115 (relative to the main memory 110) so that information may be exchanged between the CPU core 115 and the L2 cache 120 more rapidly and/or with less latency.

The illustrated cache system also includes an L1 cache 125 for storing copies of instructions and/or data that are stored in the main memory 110 and/or the L2 cache 120. Relative to the L2 cache 120, the L1 cache 125 may be implemented using smaller and faster memory elements so that information stored in the lines of the L1 cache 125 can be retrieved quickly by the CPU 105. The L1 cache 125 may also be deployed logically and/or physically closer to the CPU core 115 (relative to the main memory 110 and the L2 cache 120) so that information may be exchanged between the CPU core 115 and the L1 cache 125 more rapidly and/or with less latency (relative to communication with the main memory 110 and the L2 cache 120). Persons of ordinary skill in the art having benefit of the present disclosure should appreciate that the L1 cache 125 and the L2 cache 120 represent one exemplary embodiment of a multi-level hierarchical cache memory system. Alternative embodiments may use different multilevel caches including elements such as L0 caches, L1 caches, L2 caches, L3 caches, and the like.

In the illustrated embodiment, the L1 cache 125 is separated into level 1 (L1) caches for storing instructions and data, which are referred to as the L1-I cache 130 and the L1-D cache 135. Separating or partitioning the L1 cache 125 into an L1-I cache 130 for storing only instructions and an L1-D cache 135 for storing only data may allow these caches to be deployed closer to the entities that are likely to request instructions and/or data, respectively. Consequently, this arrangement may reduce contention, wire delays, and generally decrease latency associated with instructions and data. In one embodiment, a replacement policy dictates that the lines in the L1-I cache 130 are replaced with instructions from the L2 cache 120 and the lines in the L1-D cache 135 are replaced with data from the L2 cache 120. However, persons of ordinary skill in the art should appreciate that alternative embodiments of the L1 cache 125 may not be partitioned into separate instruction-only and data-only caches 130, 135. The caches 120, 125, 130, 135 can be flushed by writing back modified (or “dirty”) cache lines to the main memory 110 and invalidating other lines in the caches 120, 125, 130, 135. Cache flushing may be required for some instructions performed by the CPU 105, such as a RESET or a write-back-invalidate (WBINVD) instruction.

The CPU core 115 can execute programs that are formed using instructions such as loads and stores. In the illustrated embodiment, programs are stored in the main memory 110 and the instructions are kept in program order, which indicates the logical order for execution of the instructions so that the program operates correctly. For example, the main memory 110 may store instructions for a program 140 that includes the stores S1, S2 and the load L1 in program order. Persons of ordinary skill in the art having benefit of the present disclosure should appreciate that the program 140 may also include other instructions that may be performed earlier or later in the program order of the program 140. The CPU 105 includes a picker 145 that is used to pick instructions for the program 140 to be executed by the CPU core 115. In the illustrated embodiment, the CPU 105 is an out-of-order processor that can execute instructions in an order that differs from the program order of the instructions in the associated program. For example, the picker 145 may select instructions from the program 140 in the order L1, S1, S2, which differs from the program order of the program 140 because the load L1 is picked before the stores S1, S2.

The CPU 105 implements one or more store queues 150 that are used to hold the stores and associated data. In the illustrated embodiment, the data location for each store is indicated by a linear address, which may be translated into a physical address so that data can be accessed from the main memory 110 and/or one of the caches 120, 125, 130, 135. The CPU 105 may therefore include a translation look aside buffer (TLB) 155 that is used to translate linear addresses into physical addresses. When a store (such as S1 or S2) is picked, the store checks the TLB 155 and/or the data caches 120, 125, 130, 135 for the data used by the store. The store is then placed in the store queue 150 to wait for data. In one embodiment, the store queue may be divided into multiple portions/queues so that stores may live in one queue until they are picked and receive a TLB translation and then the stores can be moved to another queue. In this embodiment, the second queue is the only one that holds data for the stores. In another embodiment, the store queue 150 is implemented as one unified queue for stores so that each store can receive data at any point (before or after the pick).

One or more load queues 160 are also implemented in the embodiment of the CPU 105 shown in FIG. 1. Load data may also be indicated by linear addresses and so the linear addresses for load data may be translated into a physical address by the TLB 155. In the illustrated embodiment, when a load (such as L1) is picked, the load checks the TLB 155 and/or the data caches 120, 125, 130, 135 for the data used by the load. The load can also use the physical address to check the store queue 150 for address matches. Alternatively, linear addresses can be used to check the store queue 150 for address matches. If an address (linear or physical depending on the embodiment) in the store queue 150 matches the address of the data used by the load, then store-to-load forwarding can be used to forward the data from the store queue 150 to the load in the load queue 160. In one embodiment, store-to-load forwarding is used to forward data when the data block in the store queue 150 encompasses the requested data blocks. This may be referred to as an “exact match.” For example, when the load is a 4 byte load from address 0x100, an exact match may be a 4 B store to address 0x100. However, a 2 byte store to address 0xFF would not be an exact match because it does not encompass the 4 byte load from address 0x100 even though it partially overlaps the load. A 4 byte store to address 0x101 would also not encompass the 4 byte load from address 0x100. However, when the load is a 4 byte load from address 0x100, an 8 B store to address 0x100 may be forwarded to the load because it is “greater” than the load and fully encompasses the load.

Store-to-load forwarding may be blocked if there are stores in the store queue 150 that match the index or address of the load but are older (i.e., earlier in the program order) than the load. In one embodiment, forwarding is based on linear address checks and loads block on a match of the index bits with a store. The index bits are the same for a linear address and its physical translation and a match occurs when the linear addresses (of the load and store) are different, but they alias to the same physical address. In this embodiment, a load can get blocked on multiple stores with an index match. The load may therefore check for blocking stores when it is picked so that forwarding can be blocked if necessary. In some cases, more than one store may be blocking a load and the load may have to wait for all the blocking stores to retire before the data is forwarded to the load. A load can also be blocked by other conditions such as waiting for the stores to commit to the data cache. However, in other cases, a store may be ready to forward data to a load but it may not have received the data so it cannot forward the data. The CPU 105 may therefore identify stores that are partially qualified for store-to-load forwarding because of an address match between the load and the store but are not fully qualified for store-to-load forwarding because the store does not have the requested data. In one embodiment, the CPU 105 performs a conventional STLF calculation when a load is picked to identify stores that are fully qualified for forwarding to the load. The conventional STLF calculation is performed concurrently and/or in parallel with another STLF calculation that identifies stores that are qualified for forwarding to the load without considering the DataV term that indicates whether the store as valid data. For example, the concurrent STLF calculations may perform the operations:

StlfValid=|(StoreAddressAgeMatch[SIZE:0] & StoreDataV[SIZE:0])

CriticalBlockValid=|(StoreAddressAgeMatch[SIZE:0])

The first operation is used to determine whether a store is fully qualified and the second operation is used to determine whether the store is a critical blocking store that is partially qualified except for the fact that it does not yet have valid data.

When the calculations are finished, a fully qualified store can be used to perform store-to-load forwarding. However, if the CPU 105 does not identify any fully qualified stores and no conventional STLF is possible, the CPU 105 can determine whether any partially qualified (critically blocking) stores are present in the store queue 150. If the less-qualified version (e.g., without DataV) has a hit, the CPU 105 identifies the store as a critical block that would have forwarded its data, if not for the fact that it doesn't yet have the data. Instead of recording all the stores that would normally have blocked the load, the CPU 105 records the critical blocking store. When the recorded (critical blocking) store gets data, the load may be replayed. Since the critical blocking store now has data the CPU 105, it is fully qualified for forwarding and so the replayed load should get the expected forwarded data from the store. For example, if (˜StlfValid & CriticalBlockValid), the block information for the load records StoreAddressAgeMatch. Once that store gets data, it sends a signal to the load queue 160 to unblock the load, so the load replays and gets the forwarded data. In one embodiment, power in the CPU 105 can be saved or conserved by bypassing access, e.g., by gating off TLB/TAG access to the TLB 155 and/or the caches 120, 125, 130, 135 since the load is expecting forwarding from the store and does not need to access the cached information. In another embodiment, the store queue CAMs could be bypassed or gated off when replaying due to this critical block to save or conserve additional CPU power

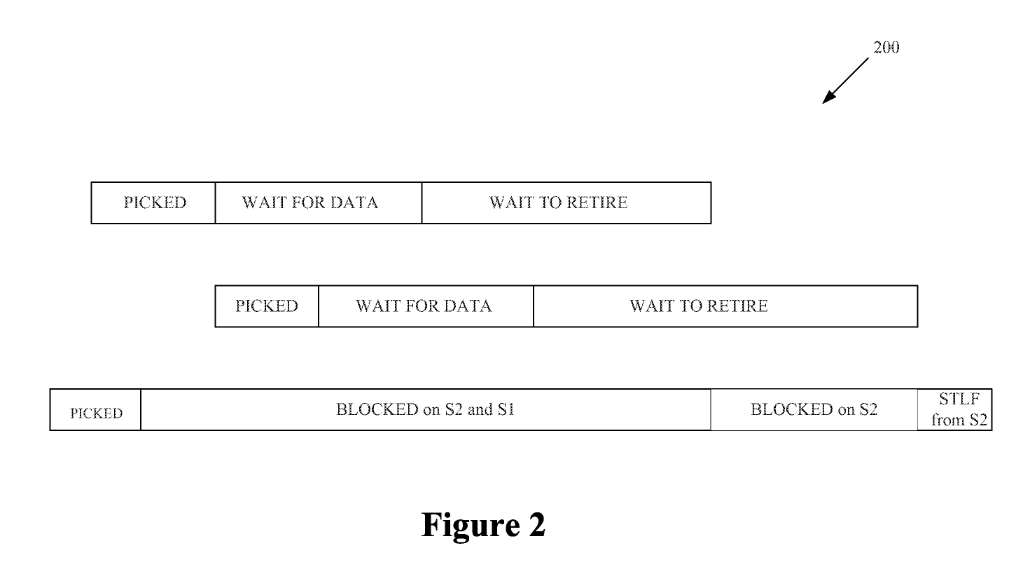

FIG. 2 conceptually illustrates a first exemplary embodiment of a sequence 200 of events during store-to-load forwarding. In the illustrated embodiment, the instructions are listed in program order in decreasing age from top-to-bottom. For example, S1 is an older instruction than S2. Time (in arbitrary units) increases from left-to-right. Instructions can be picked and processed in any order subject to any constraints imposed by dependencies between the instructions and/or the data used by the instructions. The load instruction L1 loads data from a memory/register R1 and the store instructions S1, S2 store data from the same memory/register R1. The load L1 and the stores S1, S2 may therefore be dependent upon each other and can block each other depending on the program order and the pick order of the instructions.

The load L1 is the first instruction picked for processing in FIG. 2. However, since the store instructions S1, S2 are both older than the load L1, the load L1 is blocked by the stores S1, S2. The store S1 is the next instruction picked for processing. The store S1 is picked and then it waits for data used by the instruction. After the data has been received (and placed in the store queue as described herein), the store S1 waits for a delay interval before retiring. In one embodiment, the delay interval may depend on older operations that are in-flight and/or how long it takes the re-order buffer (or retirement logic) to retire the store. The store S2 is picked for processing after the store S1 is picked. The store S2 also waits for data used by the instruction. After the data has been received (and placed in the store queue as described herein), the store S2 waits for a delay interval before retiring. In the illustrated embodiment, the load L1 remains blocked by both of the stores S1, S2 until the store S1 has retired, at which point he load L1 remains blocked by the other store S2. Since the load is blocked on both stores, and retirement is in program order, the load can get forwarded data when both stores retire. Once both stores S1, S2 have retired, store to load forwarding can be used to forward data from the store S2 (which is the youngest store) to the load L1.

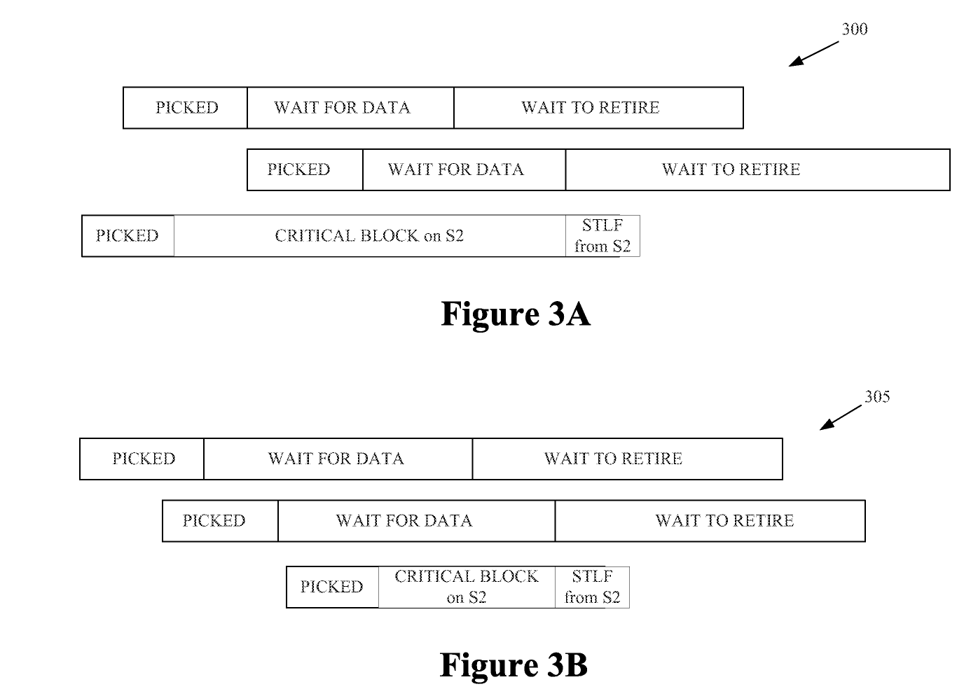

FIG. 3A conceptually illustrates a second exemplary embodiment of a sequence 305 of events during store-to-load forwarding. In the illustrated embodiment, the instructions are listed in program order in decreasing age from top-to-bottom. For example, S1 is an older instruction than S2. Time (in arbitrary units) increases from left-to-right. Instructions can be picked and processed in any order subject to any constraints imposed by dependencies between the instructions and/or the data used by the instructions. The load instruction L1 loads data from a memory/register R1 and the store instructions S1, S2 store data from the same memory/register R1. The load L1 and the stores S1, S2 may therefore be dependent upon each other and can block each other depending on the program order and the pick order of the instructions.

In the illustrated embodiment, the load L1 is picked before either of the stores S1, S2. Since the store S2 is younger than the store S1, store-to-load forwarding can be used to forward data from the store S2 to the load L1 as soon as data is available at the store S2. The load L1 is therefore critically blocked by the store S2 while the store S2 is waiting for data. Once the store S2 receives the data, the critical block may be removed and the data can be forwarded from the store S2 to the load L1. This store-to-load forwarding can occur before either of the stores S1, S2 has retired because the system knows that the data for the youngest store S2 is being forwarded and so the load L1 is getting the correct data.

FIG. 3B conceptually illustrates a third exemplary embodiment of a sequence 305 of events during store-to-load forwarding. In the illustrated embodiment, the instructions are listed in program order in decreasing age from top-to-bottom. For example, S1 is an older instruction than S2. Time (in arbitrary units) increases from left-to-right. Instructions can be picked and processed in any order subject to any constraints imposed by dependencies between the instructions and/or the data used by the instructions. The load instruction L1 loads data from a memory/register R1 and the store instructions S1, S2 store data from the same memory/register R1. The load L1 and the stores S1, S2 may therefore be dependent upon each other and can block each other depending on the program order and the pick order of the instructions.

In the illustrated embodiment, the load L1 and the stores S1, S2 are picked in program order. However, due to the latency in retrieving the data for the stores S1, S2, the load L1 is blocked by both stores S1, S2. Since the store S2 is younger than the store S1, store-to-load forwarding can be used to forward data from the store S2 to the load L1 as soon as data is available at the store S2. The load L1 is therefore critically blocked by the store S2 while the store S2 is waiting for data. Once the store S2 receives the data, this data can be forwarded from the store S2 to the load L1. This store-to-load forwarding can occur before either of the stores S1, S2 has retired because the system knows that the data for the youngest store S2 is being forwarded and so the load L1 is getting the correct data.

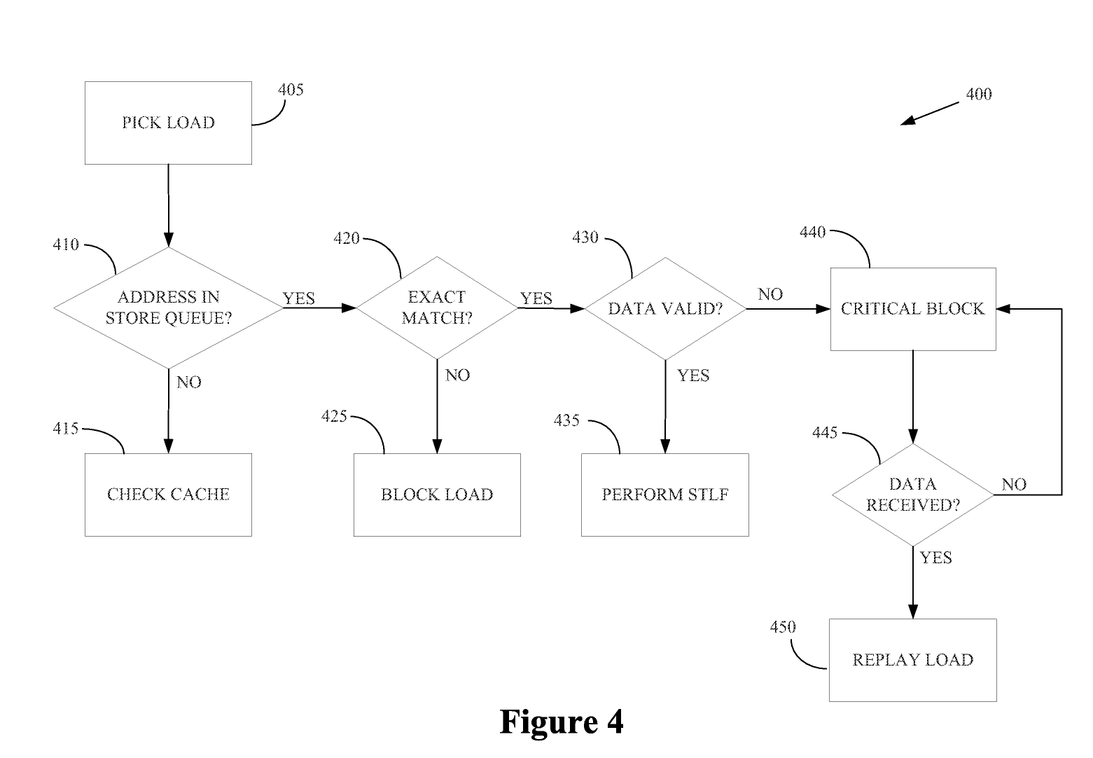

FIG. 4 conceptually illustrates one exemplary embodiment of a method 400 of handling critical blocking of store-to-load forwarding. In the illustrated embodiment, a load is picked (at 405). Picking (at 405) the load may include translating linear addresses into physical addresses and/or placing the load in a load queue. An address (linear or physical depending on the embodiment) can then be used to determine (at 410) whether the address is in the store queue that holds stores. If the address is not in the store queue, then one or more caches can be checked (at 415) to see if the addresses indicate data is stored in one or more of the caches, e.g. by comparing portions of the address to tags in a tag array associated with the cache. If the address is located in the store queue, then the system can determine (at 420) whether the requested data is an exact match to the data in the corresponding store. If the requested data is not an exact match then the load is blocked (at 425) until the blocking store is retired.

The validity of the data in the store queue is determined (at 430) when the data requested by the load overlaps and encompasses the address and data range in the store queue. This may occur when the load is an exact match to the address and data range in the store queue or when the data range of the store is greater than the data range of the load and encompasses the load range. If the store indicated by the address already includes valid data, then the store-to-load forwarding can be performed (at 435) to forward the requested data from the store queue to the load. The load may be critically blocked (at 440) when the store is qualified for store-to-load forwarding except that the store does not yet have valid data. The load remains critically blocked (at 440) until it is determined (at 445) that data has been received by the partially qualified store. The load can then be replayed (at 450) in response to determining that data has been received by the partially qualified store. Since the system has already determined that the store would be for qualified to forward data to the load except for the absence of valid data, replaying (at 450) the load in response to determining (at 445) that data has been received allows the load to be replayed (at 450) when the associated store is fully qualified and store-to-load forwarding should be available.

Although physical addresses may be used to handle critical blocking in some embodiments of the techniques described herein, linear addresses may alternatively be used. Store to load forwarding/blocking may be performed using linear addresses by taking into account that the same linear address has the same physical address due to translation. The linear address can be determined or known in advance of the physical address and is not as timing critical as the physical address. By using the linear address instead of the physical address, forwarding/blocking conditions can be determined even if the translation is no longer in the translation look-aside buffer (TLB). However, in some embodiments, multiple linear addresses can be mapped to the same physical address. A linear aliasing detection mechanism may therefore be implemented to signal a pipe flush if a store has already forwarded to a load, because they matched linear addresses, but a younger store, but still older than the load matches the physical address. For embodiments where linear aliasing does not happen frequently, it was determined that this was a fair trade-off for power and performance. Blocking may also be detected using the linear addresses. If a store does not have valid data, it may block the load in question.

Timing and thereby performance may be gained using linear addressing. On processors that involve TLB's, the physical address read-out is a critical compare and to compare it against valid stores would be in that critical path. By using linear addresses this timing critical path is eliminated and performance is gained.

Portions of the disclosed subject matter and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the disclosed subject matter are typically encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The disclosed subject matter is not limited by these aspects of any given implementation.

The particular embodiments disclosed above are illustrative only, as the disclosed subject matter may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed:

1. A method, comprising:
recording a load that matches an address of a store in a store queue before the store has valid data in response to the load being blocked because the store does not have valid data; and
replaying the load in response to the store receiving valid data so that the valid data is forwarded from the store queue to the load.

2. The method of claim 1, wherein recording the load comprises recording information indicating that the store is earlier in program order than the load and the address of the store matches the address of the load.

3. The method of claim 2, wherein recording the load comprises recording the load when the store is the latest in program order of a plurality of stores that are blocking the load.

4. The method of claim 1, wherein recording the load comprises:
determining that the store is blocking the load; and
determining that the store would be qualified to forward data to the load if the store had valid data.

5. The method of claim 4, wherein determining that the store is blocking the load comprises determining whether the store has a program order age and an address that qualifies the store to forward data to the load and determining whether the store has valid data.

6. The method of claim 5, wherein determining that the store would be qualified to forward data to the load comprises determining whether the store has a program order age and address that qualifies the store to forward data to the load.

7. The method of claim 6, wherein recording the load comprises recording the load when the store is blocking the load and the store would be qualified to forward data to the load if the store had valid data.

8. The method of claim 1, wherein replaying the load comprises unblocking the load in response to a load queue receiving a signal from the store queue indicating that the store has received valid data.

9. The method of claim 1, comprising bypassing access to at least one of a translation lookaside buffer, a cache tag array, or store queue content addressable memory when the replaying the load.

10. An apparatus, comprising:
means for recording a load that matches an address of a store in a store queue before the store has valid data in response to the load being blocked because the store does not have valid data; and
means for replaying the load in response to the store receiving valid data so that the valid data is forwarded from the store queue to the load.

11. An apparatus, comprising:
a store queue for holding store addresses and data for one or more stores; and
a processor core configured to:
record a load that matches an address of a store in the store queue before the store has valid data in response to the load being blocked because the store does not have valid data; and
replay the load in response to the store receiving valid data so that the valid data is forwarded from the store queue to the load.

12. The apparatus of claim 11, wherein recording the load comprises recording information indicating that the store is earlier in the program order than the load and the address of the store matches the address of the load.

13. The apparatus of claim 12, wherein the processor core is configured to record the load when the store is the latest in the program order of a plurality of stores that are blocking the load.

14. The apparatus of claim 11, wherein the processor core is configured to record the load by:
determining that the store is blocking the load: and
determining that the store would be qualified to forward data to the load if the store had valid data.

15. The apparatus of claim 14, wherein the processor core is configured to determine whether the store is blocking the load by determining whether the store has a program order age and an address that qualifies the store to forward data to the load and by determining whether the store has valid data.

16. The apparatus of claim 15, wherein the processor core is configured to determine that the store would be qualified to forward data to the load if the store had valid data by determining whether the store has a program order age and address that qualifies the store to forward data to the load.

17. The apparatus of claim 16, wherein the processor core is configured to record the load when the store is blocking the load and the store would be qualified to forward data to the load if the store had valid data.

18. The apparatus of claim 11, comprising a load queue and wherein the processor core is configured to replay the load by unblocking the load in response to the load queue receiving a signal from the store queue indicating that the store has received valid data.

19. The apparatus of claim 18, comprising at least one of a translation lookaside buffer, a cache tag array, or a store queue content addressable memory, and wherein the processor core is configured to bypass access to at least one of the translation lookaside buffer, the cache tag array, or the store queue content addressable memory when the replaying the load.

20. The apparatus of claim 18, comprising:
a main memory for storing the stores, the loads, and the data;
at least one cache for caching copies of the stores, the loads, or the data for use by the processor core; and
a picker for picking instructions to be performed by the processor core and providing the stores to the store queue or the loads to the load queue.
